(19) United States
(12) Patent Application Publication
(10) Pub. No.: US 2012/0048924 A1
(43) Pub. Date: Mar. 1, 2012

(54) READ ONLY CARD IDENTIFICATION SYSTEM

(75) Inventor: KA FAI HONG, Hong Kong (HK)

(73) Assignee: MYLAND LIMITED, Hong Kong (CN)

(21) Appl. No.: 12/862,801

(22) Filed: Aug. 25, 2010

(51) Int. Cl. G06K 5/00

(52) U.S. Cl. 235/382

(57) ABSTRACT

The present invention offers a read only card identification system, utilizing capacitive detector circuit as the identification apparatus to execute the function of a functional code. The system consists a bottom layer (300), which is a capacitive detector circuit board with n sensor terminals to detect the functional code of a card; A top layer (400) with n sensor plates (103) and a ground plate (402), is put on the top of the bottom layer (300), the sensor plates (103) and ground plate (402) are electrically connected with the sensor terminals (303) and the ground terminal of the bottom layer (300) respectively; A card (104), having a predetermined conductive pattern code plating inside, is used to put on the top of the top layer (400) for identification; A function executing apparatus, executes the function corresponding to the functional code.

### BACKGROUND OF THE INVENTION

1. Field of the Invention

The present invention relates to a card identification system. In particular, the present invention relates to a read only card identification system with code pattern plating on the card and recognized by a capacitive proximity detector to execute the function of a code.

2. Description of the Related Art

There are variety of card for using, such as creadid card, storage card, prepaid card, etc., most of the card need to detect a voltage signal from the card reader. U.S. Pat. No. 4,328,415, to Douglas J. Raton et al., teaches a card and card reader system and is used to enable access to the viewdata computer and to charge the account for use of the viewdata. U.S. Pat. No. 5,451,763, to David R. Pickett et al., teaches a Personal IC Card and Read/Write Unit, the IC card has two capacitve plates an multiple winding card coil for reading and writing, the card should has an IC on it. U.S. Pat. No. 6,196,465, to Kouich Awano, teaches a capacitive data card in which a fuse is built in circuit of the card and a data bit is represented by a state of the fuse, this capacitive data card comprises a capacitive memory area and a magnetic memory area to store capacitive data and magnetic data respectively. U.S. Pat. No. 3,995,255, to William E. Cuttill, teaches a cradit card by arranging high dielectric constant spot or discs and low dielectric constant spot or discs in several groupings related to a plurality of identification digits, it needs a relative high voltage level sensing circuit to reduce the possibility of error due to oxide film, dirt, or high resistance film, This system needs a lot of analog circuit. U.S. Pat. No. 5,364,272, to Herman et al., teaches an apparatus and method for teaching, includes at least one receptacle with one signal-out pad and a plurality of conductive code-in pat, and at least one remote unit with one signal-in pad and a plurality of conductive code-out pat in each face of a cube, as one face of the receptacle is capacitive coupling to the receptacle, the receptacle must sent a signal to the remote unit and read the code.

U.S. filing Ser. No. 12/382,088 to Shyuh dere Lin, the inventor of this invention, teaches an object proximity detector or position detector with reduced interference of external electrical and magnetic wave, this prior art is suitable to use in the detection circuit of the present invention.

Therefore, there is a need to have a read only card for identification in application area, without using IC on it and need not a lot of analog circuit.

### OBJECTS OF THE INVENTION

It is therefore an object of the invention to provide a read only card identification system with functional code pattern plating on the card and recognized by a detector to execute the function of a code.

It is another object of the invention to provide a read only card identification system to simplify the card identification.

### DISCLOSURE OF THE INVENTION

A first aspect of the present invention teaches a read only card identification system, utilizing capacitive detector circuit as the identification apparatus to execute the function of a functional code. The function executing apparatus can be a game, a toy, a word, a song, a door or identifying a user. The system consists a bottom layer, which is a capacitive detector circuit board with n sensor terminals to detect the functional code of a card; A top layer with n sensor plates and a ground plate, is put on the top of the bottom layer, the sensor plates and ground plate are electrically connected with the sensor terminals and the ground terminal of the bottom layer respectively; A housing, the bottom layer and the top layer are packed inside the housing; A card, made by non transparent material, having a predetermined conductive pattern code plating inside, is used to put in a receptacle on the top of the top layer for identification; A function executing apparatus, executes the function corresponding to the functional code when the card is put on the top layer and is identified by the capacitive detector circuit. The conductive functional codes are plating film of conductive material such as carbon film, metal film or transparent metal film.

### BRIEF DESCRIPTION OF THE DRAWINGS

FIG. 1 shows a perspective diagram of a read only card identification system of the present invention.

FIG. 2 is a capacitive proximity sensors circuit of the present invention.

FIG. 3 is the printed circuit of the bottom layer by using the capacitive proximity sensors IC of FIG. 2.

FIG. 4 is the capecitive plate diagram of the top layer.

FIG. 5 is the examples of some predetermined conductive pattern functional code of a card for using the the top layer of FIG. 4.

FIG. 6 (A) is an equivelent circuit of the functional code of the upper left card in FIG. 5

FIG. 6 (B) is an equivelent circuit of the code pattern 506-1 and 506-7.

FIG. 6 (C) is an equivelent circuit of the code pattern 506-2 to 506-6 and 506-8.

FIG. 7 is another embodiment of capecitive plate diagram of the top layer.

FIG. 8 is the examples of some predetermined conductive pattern functional code of a card for using the the top layer of FIG. 7.

FIG. 9 is another embodiment of capecitive plate diagram of the top layer.

FIG. 10 is the examples of some predetermined conductive pattern functional code of a card for using the top layer of FIG. 9.

### DESCRIPTION OF THE PREFERRED EMBODIMENTS

The foregoing and other advantages of the invention will be more fully understood with reference to the description of the best embodiment and the drawing as the following description.

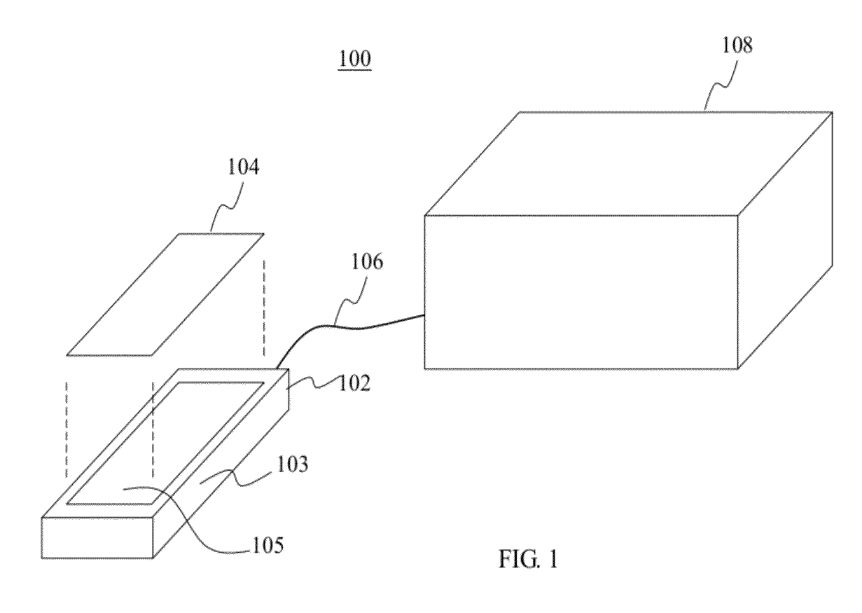

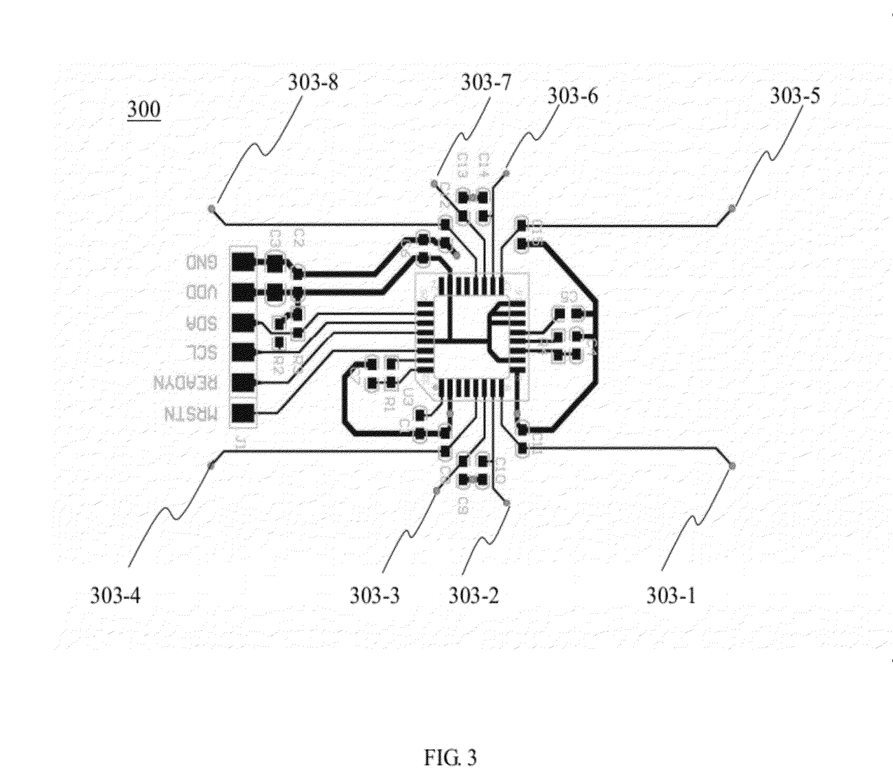

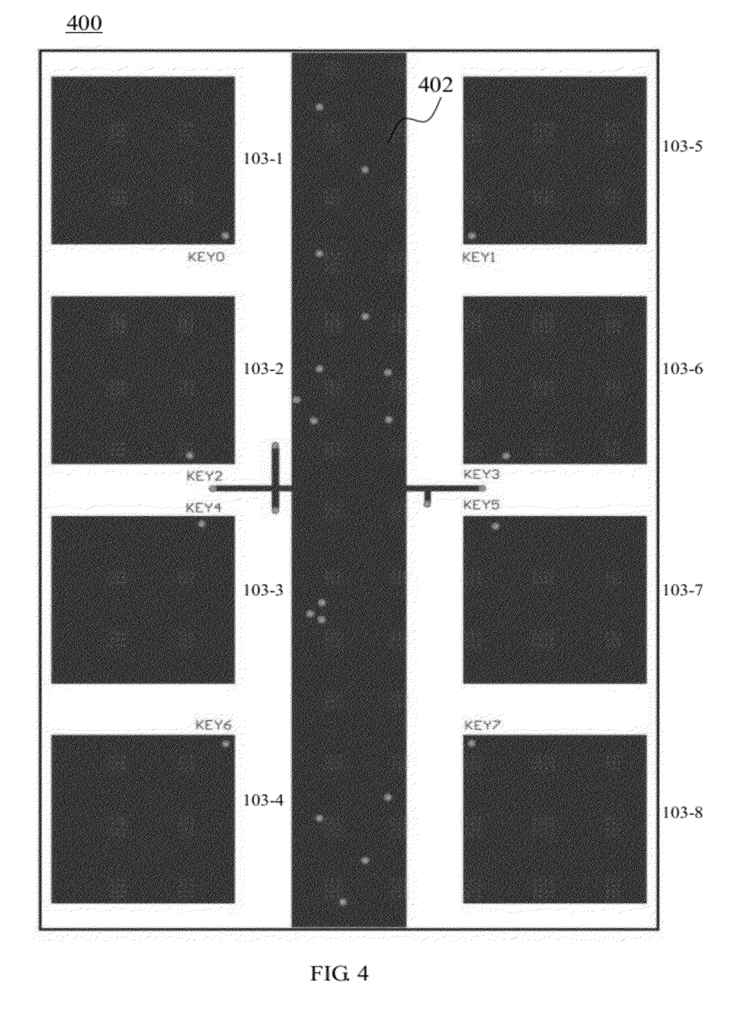

FIG. 1 shows a perspective diagram of a read only card identification system of the present invention, read unit 102 consists a housing 103, a bottom layer 300 (see FIG. 3), a top layer 400 (see FIG. 4) and a receptacle 105, both the bottom layer and the top layer are packed inside the housing 103 for protection. Receptacle 105 is to provide a card insertion so that the card 104 may only inserted one way, thus properly aligning the card 104. The read unit 102 is connected to a function executing apparatus 108 by means of a communication interface 106. In operation, the card 104 is placed in the receptacle 105 of the read unit 102. a functional code from the card can then be transferred to the function executing apparatus 108. The function executing apparatus 108 can be a game, a toy, a word, a song, a door or identifying a user.

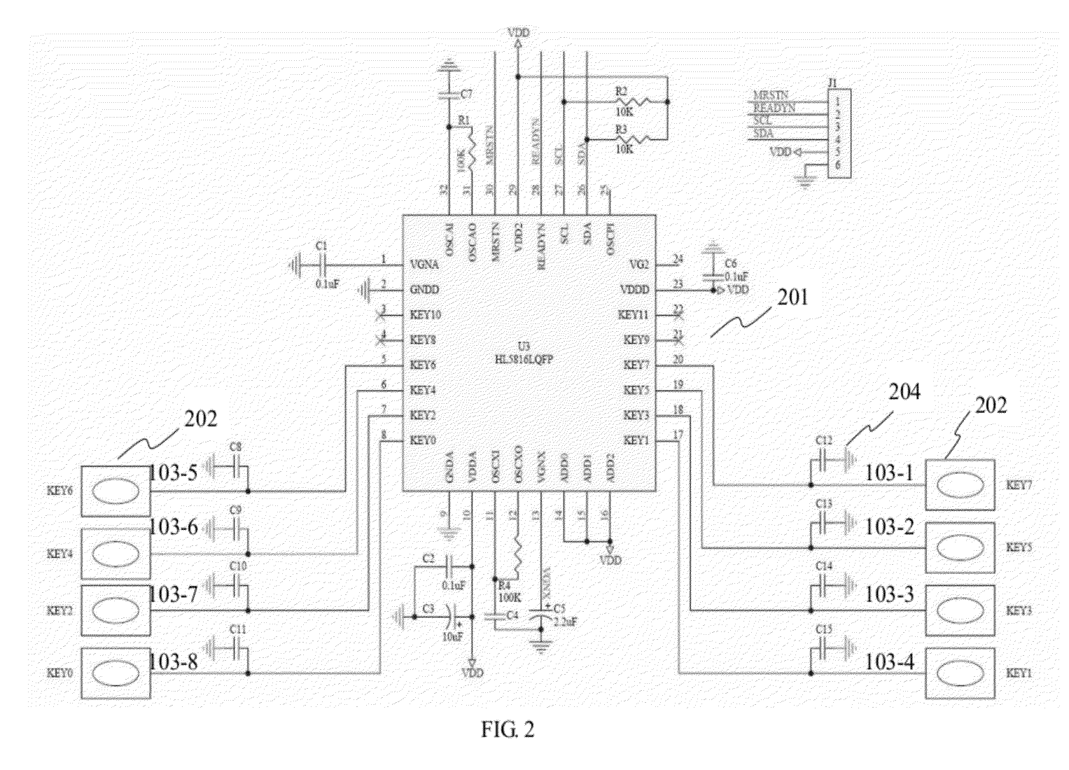

FIG. 2 is a capacitive proximity sensors circuit of the present invention. In this embodiment, a capacitive proximity sensor IC 201 is used to detect the code of the card, the keys is totally 12, we use 8 keys only, that is, 0,2,4,6 and 1,3,5,7, these keys are connected to 8 capecitive plates 202 and form plates 203-1 to 203-8.

FIG. 3 is the printed circuit of the bottom layer by using the capacitive proximity sensors IC of FIG. 2. The 8 keys is connected to contact points 303-1 to 303-8 which will contact with 8 plates on the top layer 400 (see FIG. 4).

FIG. 4 is the capecitive plate diagram of the top layer. The capecitive plate 400 has n (for example 8) plates 103-1 to 103-8 and a ground plate 402, the sensor plates is arranged on both sides of the ground plate, these plates are contact with the ground and the contact points 303-1 to 303-8 so that connected to the ground and key 0,2,4,6 and 1,3,5,7 of the capacitive proximity sensor.

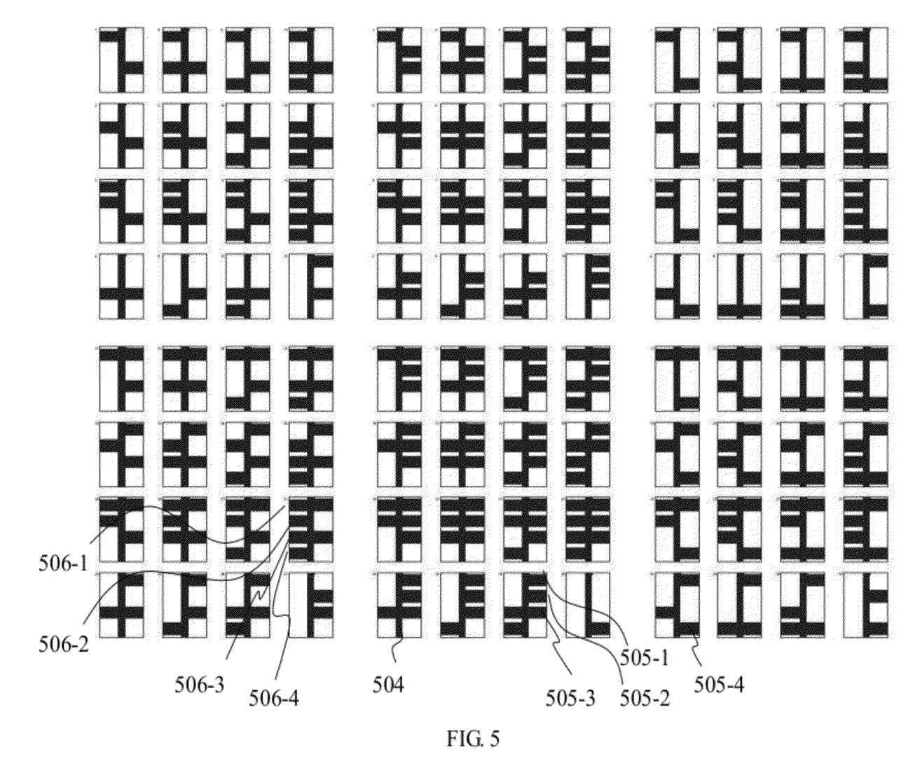

FIG. 5 is the examples of some predetermined conductive pattern functional code of a card for using the the top layer of FIG. 4. The card is made by non transparent insulating material, having conductive pattern functional code plated inside, the functional code consists of a ground pattern 504, and selected 1 to n code patterns, for example, 8 code patterns from the code pattern 506-1 to 506-8, the total functional code number is 2ⁿ, in this example, 2⁸=256−2=254 (00000000 and 11111111 are omitted). For example, the functional code of the upper left card is 10000010. The conductive functional codes are plating film of conductive material such as carbon film, metal film or transparent metal film.

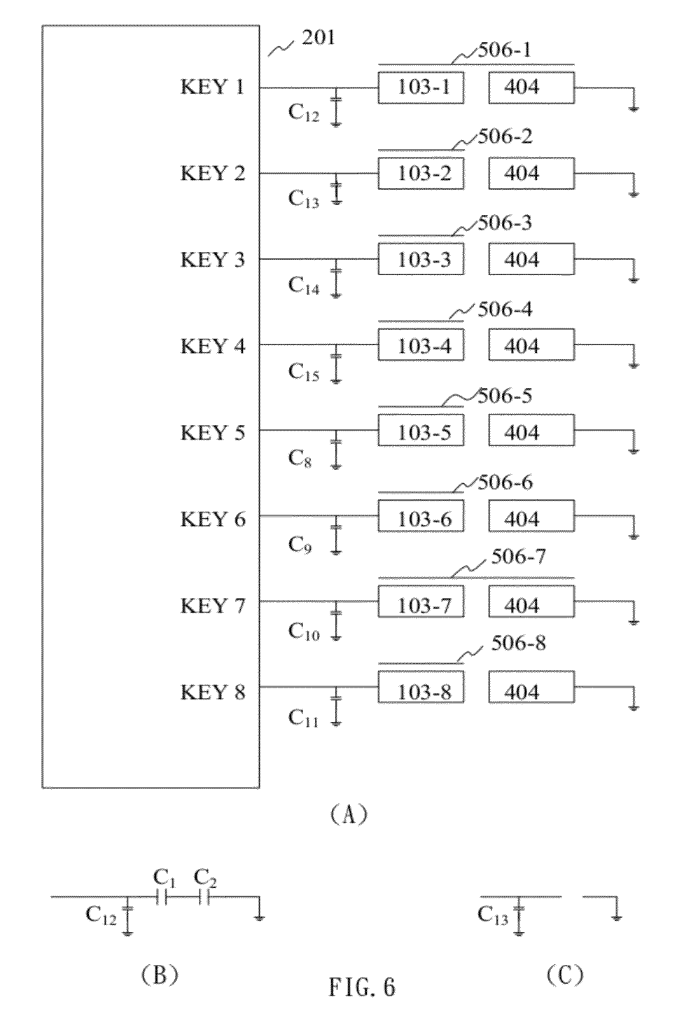

FIG. 6 (A) is an equivelent circuit of the functional code of the upper left card in FIG. 5, where the code pattern 506-1 and 506-7 of the card is grounded and form a capecitance Csub.1 with plate 103-1 and a capecitance Csub.2 with plate 404, the equivelent circuit is shown in FIG. 6 (B), thus the impedence of KEY1 is low and represent 1. The other code pattern 506-2 to 506-6 and 506-8 is not grounded, the equivelent circuit is shown in FIG. 6 (C), thus the impedence of KEY2 is high and represent 0, so that the functional code is 10000010.

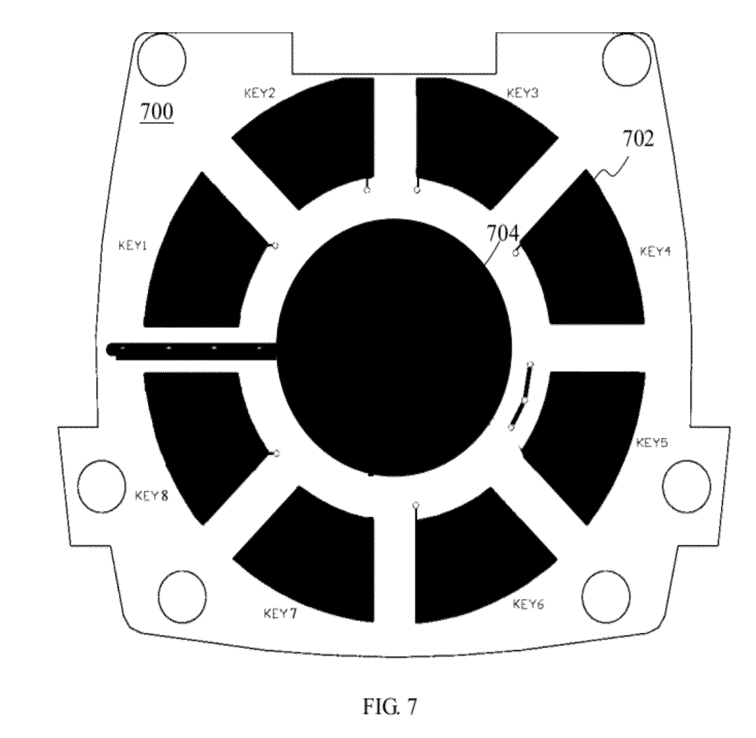

FIG. 7 is another embodiment of capecitive plate diagram of the top layer. The capecitive plate 700 also has n (for example 8) plates 702 formed a circle, and a ground plate 704 on the center, these plates are contact with the ground and the contact points 303-1 to 303-8 so that connected to the ground and key 0,2,4,6 and 1,3,5,7 of the capacitive proximity sensor.

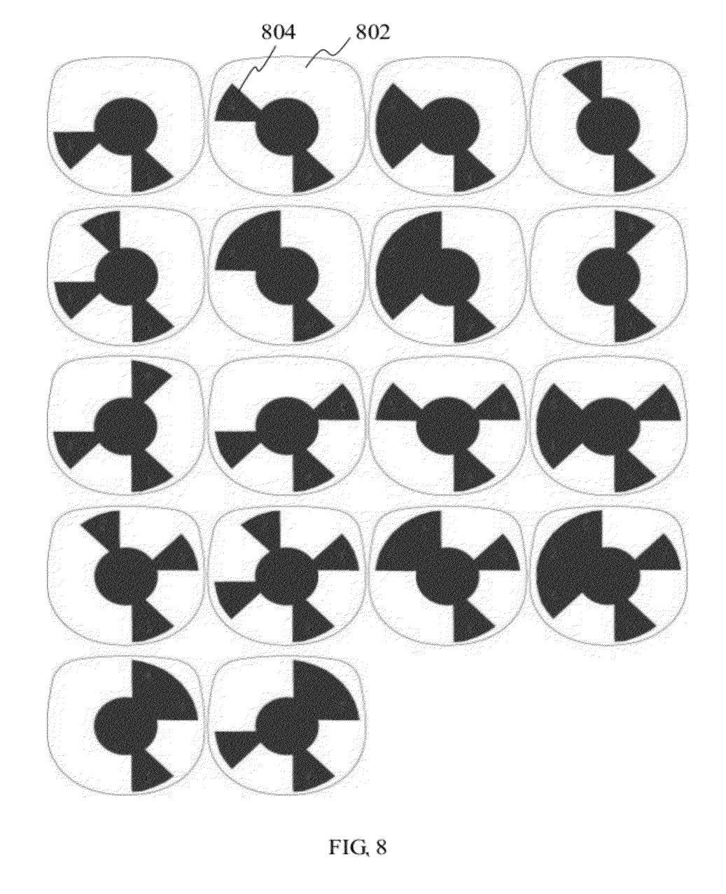

FIG. 8 is the examples of some predetermined conductive pattern functional code of a card for using the the top layer of FIG. 7. The card is made by non transparent insulating material, having conductive pattern functional code plated inside, the functional code consists of a ground pattern 804, and selected 1 to n code patterns, for example, 8 code patterns from the code pattern, the total functional code number is 2ⁿ, in this example, 2⁸=256−2=254 (00000000 and 11111111 are omitted). For example, the functional code of the upper left card is 01000001. The conductive functional codes are plating film of conductive material such as carbon film, metal film or transparent metal film.

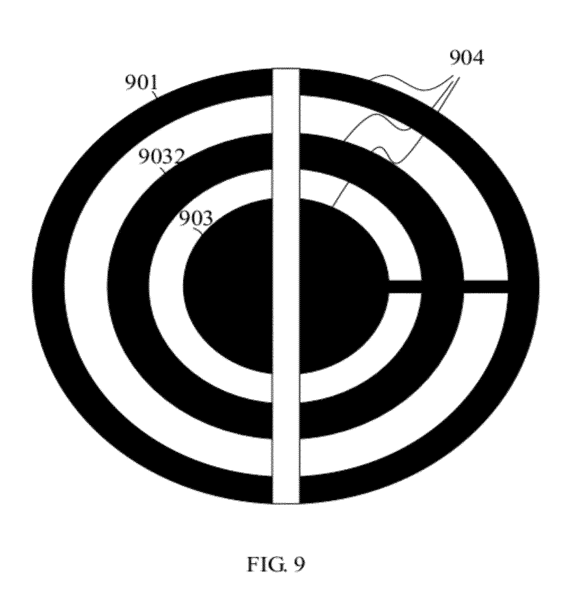

FIG. 9 is another embodiment of capecitive plate diagram of the top layer. The capecitive plate 900 has 3 plates 901, 902 and 903 formed in the left half circle as key1, key2 and key3, and a ground plate 904 on the right half circle, these plates are contact with the ground and the contact points 303-1 to 303-3 so that connected to the ground and key 0,2,4,6 and 1,3,5,7 of the capacitive proximity sensor.

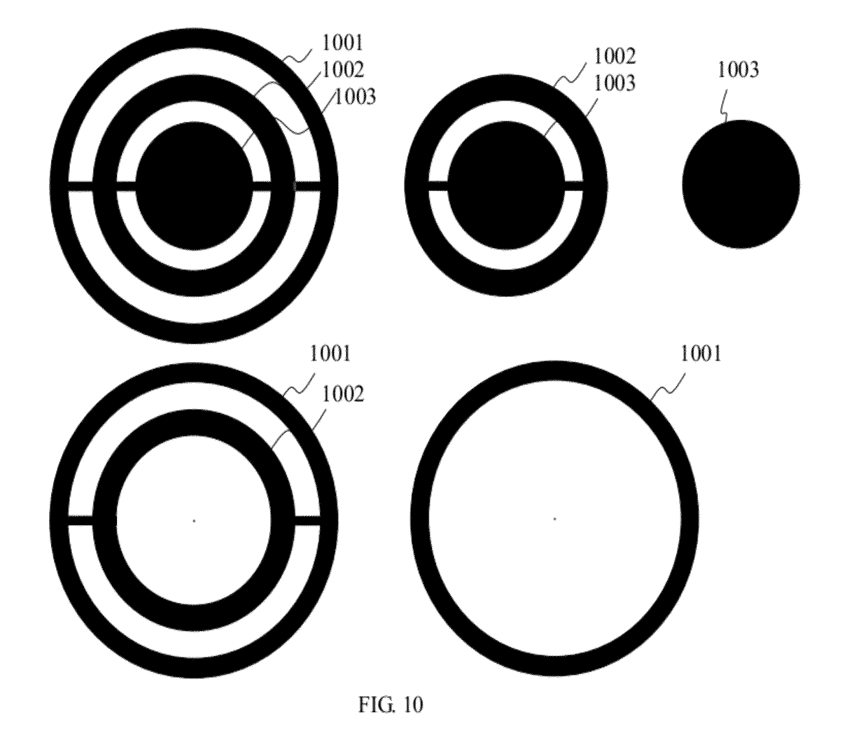

FIG. 10 is the examples of some predetermined conductive pattern functional code of a card for using the the top layer of FIG. 9. The card is made by non transparent insulating material, having conductive pattern functional code plated inside, the functional code is a circle, and selected 1 to n code patterns, for example, 3 code patterns from the code pattern 901, 902 and 903, the total functional code number is 2ⁿ, in this example, 2³=8−1=7 (000 is omitted). For example, the functional code of the lower left card is 110. the card is effective in any orientation. The conductive functional codes are plating film of conductive material such as carbon film, metal film or transparent metal film.

Although specific embodiments of the invention have been disclosed, it will be understood by those having skill in the art that minor changes can be made to the form and details of the specific embodiments disclosed herein, without departing from the scope of the invention. The embodiments presented above are for purposes of example only and are not to be taken to limit the scope of the appended claims.

What is claimed is:

1. A read only card identification system, utilizing a capacitive detector circuit as the identification apparatus to execute the function of a code, comprising:
a bottom layer, which is a capacitive detector circuit board with n sensor terminals to detect the functional code of a card;
a top layer with n sensor plates and a ground plate, is put on the top of said bottom layer, said sensor plates and said ground plate are electrically connected with said sensor terminals and ground terminal of said bottom layer respectively;
a housing, said bottom layer and said top layer are packed inside said housing;
a card, made by non transparent insulating material, having a predetermined conductive pattern functional code plating inside, is used to put in a receptacle on the top of said top layer for identification;
a function executing apparatus, executes the function corresponding to the functional code when said card is put on said top layer and is identified by said capacitive detector circuit.

2. A read only card identification system as recited in claim 1, wherein said sensor plates is arranged on both sides of said ground plate.

3. A read only card identification system as recited in claim 1, wherein said sensor plates form a circle said ground plate is on the center.

4. A read only card identification system as recited in claim 1, wherein said sensor plates are formed in the left half circle and said ground plate is formed on the right half circle.

5. A read only card identification system as recited in claim 1, wherein said conductive pattern code plating is carbon film.

6. A read only card identification system as recited in claim 1, wherein said conductive pattern code plating is metal film.

7. A read only card identification system as recited in claim 1, wherein said conductive pattern code plating is transparent metal film.

8. A read only card identification system as recited in claim 1, wherein said function is a game.

9. A read only card identification system as recited in claim 1, wherein said function is an action of a toy.

10. A read only card identification system as recited in claim 1, wherein said function is a word.

11. A read only card identification system as recited in claim 1, wherein said function is a song.

12. A read only card identification system as recited in claim 1, wherein said function is a key of a door.

13. A read only card identification system as recited in claim 1, wherein said function is to identify a user.
